(19) United States
(12) Patent Application Publication
(10) Pub. No.: US 2007/0215200 A1
(43) Pub. Date: Sep. 20, 2007

(54) Blind type solar cell and array thereof

(75) Inventor: Sang-Hoon Lim, Seo-Gu (KR)

Correspondence Address: OBLON, SPIVAK, MCCLELLAND, MAIER & NEUSTADT, P.C., 1940 DUKE STREET, ALEXANDRIA, VA, 22314, US

(73) Assignee: KOREA INSTITUTE OF ENERGY RESEARCH, Yuseong-Gu (KR)

(21) Appl. No.: 11/418,301

(22) Filed: May 5, 2006

(30) Foreign Application Priority Data
Mar. 17, 2006 (KR) 10-2006-0024708

(51) Int. Cl. H02N 6/00

(52) U.S. Cl. 136/246

(57) ABSTRACT

A blind type solar cell assembly has a blind structure to serve not only as a light shading plate but also as a light collecting device. The solar cell assembly comprises a plurality of solar cells, each being formed by stacking an electrode layer and a semiconductor layer, such that the solar cells are disposed on an outer surface of a blind member having an elongated plate shape, and electrically connected in parallel or in series with each other. A blind type solar cell array comprises a plurality of blind members connected with each other via two or more connection strings, solar cells respectively disposed on outer surfaces of the blind members so as to be electrically connected in parallel or in series with each other, and an electric wire to electrically connect the solar cells disposed on the blind members with each other in series or in parallel.

### BACKGROUND OF THE INVENTION

1. Field of the Invention

The present invention relates to a solar cell, and more particularly, to a blind type solar cell, which has a shape of a blind so as to serve not only as a light shading plate but also as a light collecting unit. In addition, the present invention relates to a solar cell array, which comprises solar cells formed on outer surfaces of blind members such that the solar cells are connected with each other so as to act as blinds while collecting light at the same time.

2. Description of the Related Art

Electric energy can be obtained with various electric power generators, one of which is a solar cell.

The solar cell is a power generator which collects and converts solar energy into electric energy, and is generally used as a power source for a heater in a building or for small electric devices.

The solar cell generally comprises a semiconductor device to convert solar energy into electric energy and an electrode layer formed on a rear side thereof. The solar cell is installed at a high place such as a roof in order to collect greater quantities of light.

However, such an installation of the solar cell at the high place such as the roof as mentioned above causes inconvenience to manage the solar cell, and restriction in utility of the solar cell.

### SUMMARY OF THE INVENTION

The present invention has been made to solve the above problems, and it is an object of the present invention to provide a blind type solar cell, which has a shape of a blind to serve not only as a light shading plate but also as a light collecting device.

It is another object of the present invention to provide a blind type solar cell array, which comprises solar cells disposed on outer surfaces of blind members such that the solar cells are connected with each other so as to act as blinds while collecting light at the same time.

In accordance with one aspect of the present invention, the above and other objects can be accomplished by the provision of a blind type solar cell assembly, comprising a plurality of solar cells, each being formed by stacking an electrode layer and a semiconductor layer, wherein the solar cells are disposed on an outer surface of a blind member having an elongated plate shape, and electrically connected in parallel or in series with each other.

In accordance with another aspect of the present invention, there is provided a blind type solar cell array, comprising a plurality of blind members connected with each other by connection strings, and a plurality of solar cells disposed on an outer surface of each blind member so as to be electrically connected in parallel or in series with each other by an electric wire.

### BRIEF DESCRIPTION OF THE DRAWINGS

The foregoing and other objects and features of the present invention will be more clearly understood from the following detailed description taken in conjunction with the accompanying drawings, in which:

FIG. 1 is a perspective view illustrating one example of a solar cell in accordance with the present invention;

FIG. 2 is a perspective view illustrating one example of a solar cell array in accordance with the present invention;

FIGS. 3a and 3b are horizontal section views illustrating the solar cell in accordance with the present invention, in which FIG. 3a shows an open state of blind members, and FIG. 3b shows a closed state thereof;

FIG. 4 is a perspective view illustrating another example of the solar cell in accordance with the present invention; and

FIG. 5 is a perspective view illustrating another example of the solar cell array in accordance with the present invention.

### DESCRIPTION OF THE PREFERRED EMBODIMENTS

Preferred embodiments of the present invention will be described in detail with reference to the accompanying drawings.

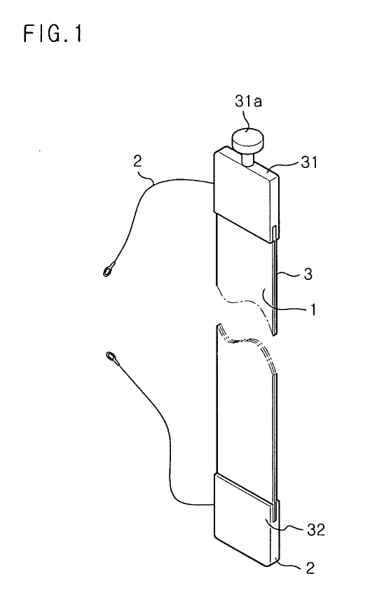

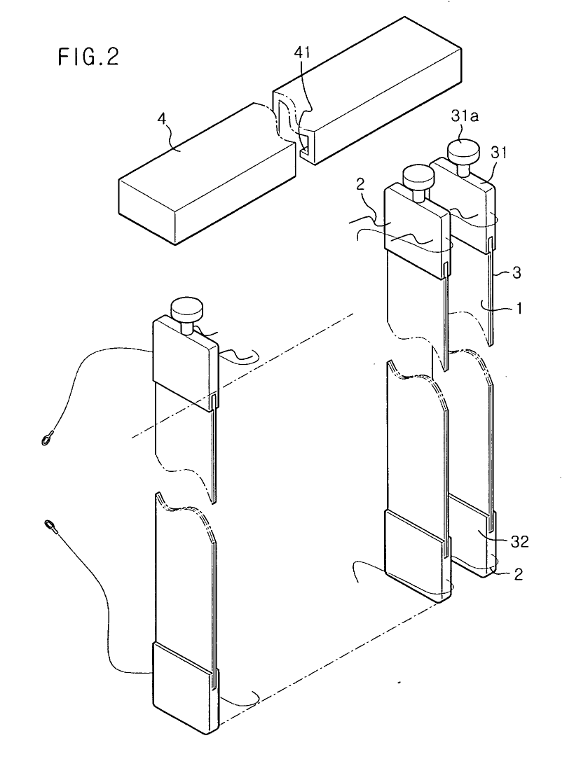

FIG. 1 is a perspective view illustrating a solar cell according to one embodiment of the present invention, and FIG. 2 is a perspective view illustrating a solar cell array of the solar cells shown in FIG. 1.

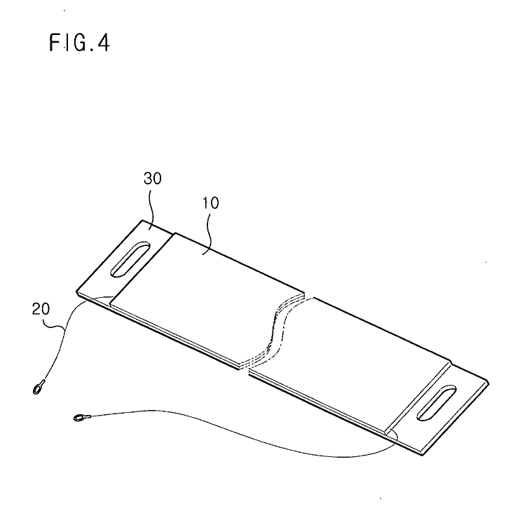

Referring to FIGS. 1 and 4, a blind type solar cell assembly according to the invention comprises a blind member 3 or 30, and a solar cell 1 or 10 installed on one side of the blind member 3 or 30.

The solar cell 1 or 10 has the same structure as a conventional solar cell, which comprises a semiconductor layer to generate electricity in response to light, and an electrode layer to transmit the electricity generated from the semiconductor layer, and thus detailed description thereof will be omitted hereinafter.

In this regard, the solar cell of the present invention is different from the conventional solar cell in that the solar cell of the invention is manufactured as a blind type solar cell so as to serve not only as the solar cell but also as a member of blinds.

As shown in FIGS. 1 and 4, the solar cell according to the present invention may be modified according to a type of blind. First, a solar cell according to one embodiment of the present invention will be described with reference to FIGS. 1 to 3b.

The solar cell 1 is formed on an outer surface of a blind member 3.

Preferably, after separately producing the solar cell 1 and the blind member 3, the solar cell 1 is bonded to the blind member 3. Alternatively, the solar cell 1 may be integrally formed with the blind member 3.

As such, since the solar cell 1 and the blind member 3 are separately produced, the solar cell 1 can be changed in its size. In addition, since the solar cell 1 is supported by the blind member 3, it can be protected by the blind member 3.

As shown in FIG. 1, with the solar cell 1 formed only in the central region on the outer surface of the blind member 3, the blind member 3 has an upper clip 31 provided at an upper end thereof to hold the blind member to the ceiling, a lower clip 32 provided at a lower end thereof to act as an anchor, which enables the blind member 3 to suspend vertically from the ceiling, and connection strings 33 connecting the upper and lower clips 31 and 32 with other upper and lower clips 31 and 32, respectively.

In this manner, a solar cell array which comprises a plurality of solar cells 1 arranged in line can be constructed by connecting the upper and lower clips 31 and 32 at both ends of each blind member 3 with the other upper and lower clips 31 and 32 of other blind members. In the solar cell array, the solar cells 1 can be assembled to each other by electrically connecting the solar cells 1 in parallel or in series with each other.

FIG. 2 illustrates one example of the solar cell array formed to constitute vertical type blinds by connecting the blind type solar cells with each other.

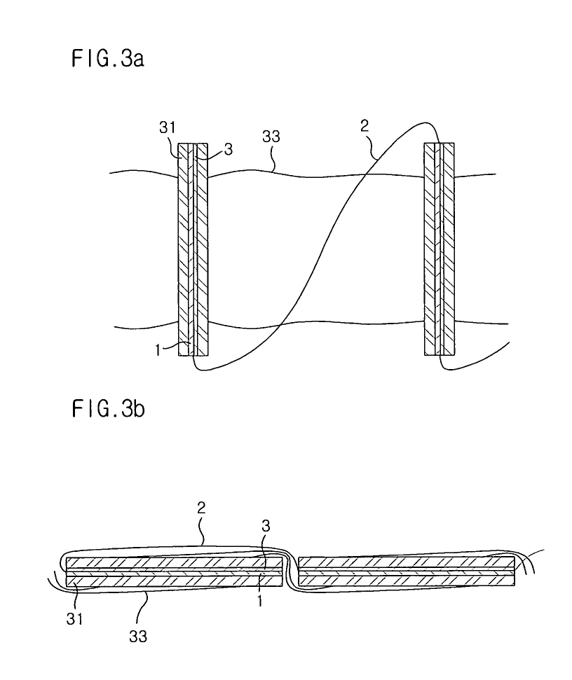

A plurality of blind type solar cells 1 described above are connected with each other via an electric wire 2. Here, the electric wire 2 is sufficiently longer than the connection strings 33 which connect the blind members 3 with each other so that, even when the blind members 3 are separated from each other as shown in FIGS. 3a and 3b, the electric wire 2 is prevented from being cut off.

One of the solar cells 1 connected with each other is provided with a connection terminal through which the solar cell array is connected with an external device and the like.

The vertical blind type solar cells constructed as described above become a closed state as shown in FIG. 3b by pulling one of the strings 33 at both sides of the blind members, and become an open state as shown in FIG. 3a by pulling the other.

A mechanism to handle the connection strings 33 is the same as that of typical blinds, and thus detailed description thereof will be omitted hereinafter.

FIG. 4 is a perspective view illustrating another example of the solar cell according to the present invention.

In this example, the solar cell is constructed as for a member of horizontal type blinds shown in FIG. 4.

The overall structure of the solar cell is similar to that of the vertical blind type solar cell described above. Exceptionally, the solar cell 10 is formed on an outer surface of the blind member 30 which will be installed horizontally.

With the solar cell 10 formed in the central region of the blind member 30 excluding both ends thereof, the blind member 30 is formed at both ends with openings to suspend the blind member 30.

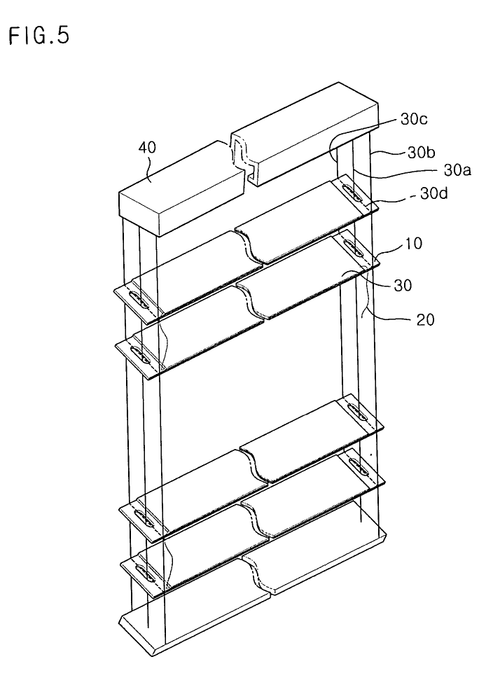

As shown in FIG. 5, the blind members 30 are connected with each other via plural connection strings 30a, 30b, 30c and 30d in a suspended state as shown in FIG. 5, so that the solar cells 1 are connected with each other, and constitute a single solar cell array.

As in the vertical blind type solar cells described above, the solar cells 10 are electrically connected in series or in parallel with each other.

The connection strings comprise an intermediate string 30a penetrating each opening at either end of the blind member 30, a fulcrum string 30d traversing the bottom of each blind member 30, and regulating strings 30b and 30c connected with both ends of the fulcrum string 30d such that, when pulling the regulating string 30c upwardly, the blind members 30 become a closed state, and when pulling the regulating string 30b, the blind members 30 become an open state.

A mechanism to handle the regulating strings 30b and 30c, and a mechanism to drive them are the same as those of the typical blinds, and thus detailed description thereof will be omitted hereinafter.

Reference numerals 4 and 40 denote members to suspend the blind member 3 or 30 to the ceiling, which has the same structure as that of the typical blinds, and thus detailed description thereof will be omitted.

As apparent from the above description, the blind type solar cell of the present invention has the structure of the blind, thereby serving not only as the light shading plate but also as the light collecting unit.

It should be understood that the embodiments and the accompanying drawings have been described for illustrative purposes and the present invention is limited only by the following claims. Further, those skilled in the art will appreciate that various modifications, additions and substitutions are allowed without departing from the scope and spirit of the invention as set forth in the accompanying claims.

What is claimed is:

1. A blind type solar cell assembly, comprising a plurality of solar cells, each being formed by stacking an electrode layer and a semiconductor layer, wherein the solar cells are disposed on an outer surface of a blind member having an elongated plate shape, and electrically connected in parallel or in series with each other.

2. A blind type solar cell array, comprising:
a plurality of blind members connected with each other via two or more connection strings, each blind member having an elongated plate shape;
a plurality of solar cells disposed on an outer surface of each blind member so as to be electrically connected in parallel or in series with each other; and
an electric wire to electrically connect the solar cells disposed on the blind members with each other in series or in parallel.

3. The solar cell array as set forth in claim 2, wherein the electric wire is longer than each connection string.
